(19) United States
(12) Patent Application Publication
(10) Pub. No.: US 2025/0284119 A1
(43) Pub. Date: Sep. 11, 2025

(54) SCANNING APPARATUS, SCANNING METHOD, AND STORAGE MEDIUM

(71) Applicant: CANON KABUSHIKI KAISHA, Tokyo (JP)

(72) Inventor: KOICHI SUZUKI, Kanagawa (JP)

(21) Appl. No.: 19/216,432

(22) Filed: May 22, 2025

Related U.S. Application Data
(63) Continuation of application No. PCT/JP2023/041482, filed on Nov. 17, 2023.

(30) Foreign Application Priority Data
Nov. 28, 2022 (JP) 2022-189179

(51) Int. Cl. G02B 26/10; G01N 21/64; G02B 26/08

(52) U.S. Cl. CPC G02B 26/101; G01N 21/6452; G02B 26/0816; G01N 2201/105

(57) ABSTRACT

A scanning apparatus according to the present invention includes an observation optical system configured to radiate primary light toward one surface to acquire optical information related to at least a portion of a plurality of spots, a scanning unit configured to perform main scanning in which the observation optical system moves relative to an array plate 101 in a first direction and acquires the optical information and sub-scanning in which the observation optical system moves relative to the array plate 101 in a second direction intersecting the first direction without acquiring the optical information, and an adjustment unit configured to adjust a position of the observation optical system relative to the array plate 101 in an optical axis direction of the primary light. The adjustment unit performs the adjustment in a case where the scanning unit is in a period of the sub-scanning.

### CROSS-REFERENCE TO RELATED APPLICATIONS

This application is a Continuation of International Patent Application No. PCT/JP2023/041482, filed Nov. 17, 2023, which claims the benefit of Japanese Patent Application No. 2022-189179, filed Nov. 28, 2022, both of which are hereby incorporated by reference herein in their entirety.

### BACKGROUND OF THE INVENTION

### Field of the Invention

The present invention relates to a scanning apparatus, a scanning method, and a storage medium.

### Background Art

A protein array plate or peptide array plate in which a large number of biomolecules such as proteins and peptides with peptide bonds are immobilized on a substrate is known. By using this, interactions with the large number of biomolecules immobilized on the substrate can be performed simultaneously. Such an array plate is effective for comprehensively analyzing the interactions between bio-derived liquid samples, such as blood, cell extracts, saliva, or interstitial fluid, and a large number of proteins or peptides. Through such analysis, the characteristics of the samples can be measured.

The immobilized sites of proteins or peptides on the substrate are referred to as spots. As a method for observing a spot that has interacted with a sample, for example, a method for identifying which spot has interacted by labeling the spots with a fluorescent probe is known. A microarray scanner is known as an apparatus for observing an array plate labeled with a fluorescent probe.

The specification of U.S. Pat. No. 7,911,670 discusses a microarray scanner including an irradiation optical system, a fluorescence detection optical system, and a two-dimensional scanning system. The irradiation optical system has the function of focusing and radiating laser light onto an array plate. The fluorescence detection optical system has the function of detecting the fluorescence light intensity from a spot labeled with a fluorescent probe. The two-dimensional scanning system has the function of acquiring a fluorescence image of a spot on the array plate by performing two-dimensional scanning of the array plate or optical system. Further, a confocal point optical system is used as the fluorescence detection optical system.

Patent No. 5281756 discusses a scanning optical apparatus that simplifies position adjustment in a height direction during fluorescence image acquisition.

### CITATION LIST

### Patent Literature

PTL 1: U.S. Pat. No. 7,911,670
PTL 1: Patent No. 5281756

Due to individual differences in the glass thickness and tilt of an array plate, a confocal optical system with a shallow depth of focus has the issue that acquiring a fluorescence image in focus across the entire surface of the array plate is difficult.

In the specification of U.S. Pat. No. 7,911,670, automatic focus adjustment using a focus sensor is performed simultaneously with two-dimensional scanning in order to obtain a fluorescence image in focus across the entire surface of the array plate. However, to perform automatic focus adjustment with high accuracy simultaneously with high-speed two-dimensional scanning of the array plate or optical system, a high-speed feedback control system composed of a high-performance focus sensor and a low-vibration actuator is necessary, which increases the complexity of the apparatus.

In U.S. Pat. No. 5,281,756, to obtain a fluorescence image in focus across the entire surface of the array plate, two-dimensional scanning needs to be repeated a plurality of times while changing the focusing position and setting parameters, which increases the fluorescence measurement time.

### SUMMARY OF THE INVENTION

The present invention has been developed in view of the above-described issue and is directed to acquiring in-focus optical information in a short time.

A scanning apparatus configured to cause an observation optical system to scan over an array plate including a plurality of spots on one surface includes an observation optical system configured to radiate primary light toward the one surface to acquire optical information related to at least a portion of the plurality of spots, a scanning unit configured to perform main scanning in which the observation optical system moves relative to the array plate in a first direction and acquires the optical information and sub-scanning in which the observation optical system moves relative to the array plate in a second direction intersecting the first direction without acquiring the optical information, and an adjustment unit configured to adjust a position of the observation optical system relative to the array plate in an optical axis direction of the primary light, wherein the adjustment unit performs the adjustment in a case where the scanning unit is in a period of the sub-scanning.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a specimen measurement apparatus according to a first embodiment.

FIG. 2A is an XY-plane view illustrating a configuration of an array plate.

FIG. 2B is a cross-sectional view illustrating a configuration of the array plate.

FIG. 3 is a diagram illustrating an internal configuration of a controller according to the first embodiment.

FIG. 4 is a flowchart illustrating operations of a scanning apparatus according to the first embodiment.

FIG. 5A is a diagram illustrating a scanning region of the scanning apparatus on the array plate according to the first embodiment.

FIG. 5B is a diagram illustrating sub-scanning trajectories of the scanning apparatus according to the first embodiment.

FIG. 5C is a partial enlarged view illustrating sub-scanning trajectories of the scanning apparatus according to the first embodiment.

FIG. 6A is a diagram illustrating an example of a height distribution of an array substrate in a sub-scanning direction detected by the scanning apparatus according to the first embodiment.

FIG. 6B is a diagram illustrating an example of a height distribution of an array substrate in a sub-scanning direction detected by the scanning apparatus according to the first embodiment.

FIG. 7 is a flowchart illustrating operations of acquiring height information according to the first embodiment.

FIG. 8A is a diagram illustrating a scanning region on an array plate in an operation of acquiring height information.

FIG. 8B is a diagram illustrating a positional relationship of heigh scanning in an operation of acquiring height information.

FIG. 8C is a diagram illustrating a positional relationship of heigh scanning in an operation of acquiring height information.

FIG. 9 is a diagram illustrating a positional relationship of sub-scanning of a scanning apparatus according to a second embodiment.

FIG. 10 is a flowchart illustrating an operation of the scanning apparatus according to the second embodiment.

FIG. 11 is a diagram illustrating an internal configuration of a controller according to a third embodiment.

FIG. 12 is a diagram illustrating an operation of a piston-crank mechanism.

FIG. 13 is a flowchart illustrating an operation of a coordinate calculation circuit according to the third embodiment.

### DESCRIPTION OF THE EMBODIMENTS

Preferred embodiments of the present invention will be described below with reference to the attached drawings.

### First Embodiment

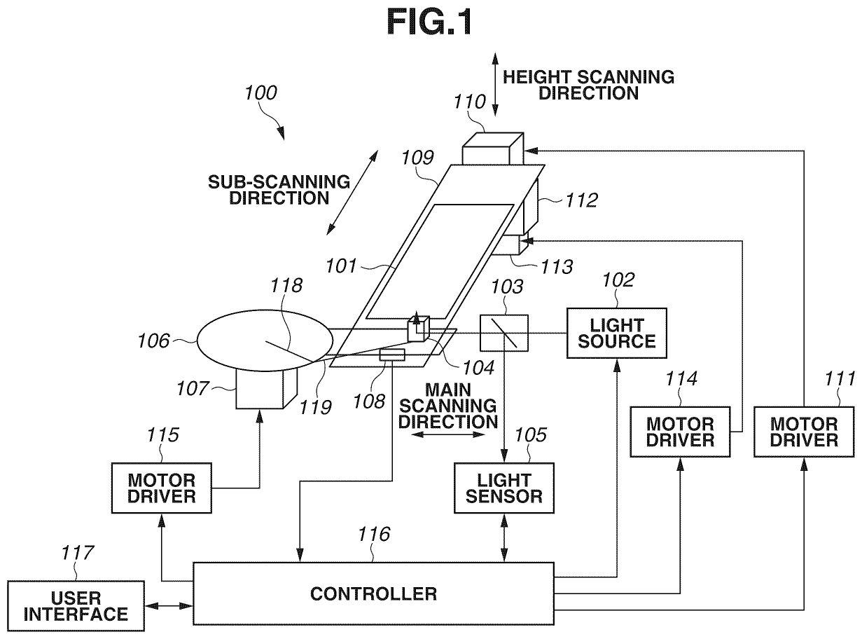

FIG. 1 is a schematic diagram illustrating a configuration of a specimen measurement apparatus 100 according to a first embodiment.

The specimen measurement apparatus 100 functions as a scanning apparatus that scans a target. The specimen measurement apparatus 100 measures a specimen as a target located on one surface of an array plate 101. A number of biomolecules are immobilized at the spots on a glass slide of the array plate 101 and fluorescently labeled.

A light source 102 is a semiconductor laser configured to emit light having wavelengths near 670 nm.

A confocal optical system 103 guides excitation light from the light source 102 to the array plate 101 and guides fluorescence from the spots of the array plate 101 and reflected light from a front surface (upper surface) of the array plate 101 to a light sensor 105. The confocal optical system 103 is composed of a pinhole, a filter, a dichroic mirror, a quarter-wave plate, a polarizing beam splitter, and a lens. Using the confocal optical system 103 reduces the influence of fluorescent components from the glass slide of the array plate 101 itself, thereby improving the signal-to-noise ratio in the measurement of fluorescent components originating from the spots.

A light directing unit 104 radiates excitation light onto the spots on the array plate 101. The light directing unit 104 is composed of a prism for directing the excitation light toward the array plate 101 and a lens for focusing the excitation light onto the spots on the array plate 101. In the present embodiment, the light directing unit 104 is positioned below the array plate 101 and radiates excitation light upward. Further, the light directing unit 104 is configured to radiate excitation light as primary light onto a target and capture fluorescence as secondary light. The light directing unit 104 corresponds to an example of an observation optical system.

A light sensor 105 converts light into an electric signal. The light sensor 105 can use a photomultiplier tube and/or a photodiode. The light sensor 105 can separately acquire fluorescence from the spots on the array plate 101 and reflected light from the front surface of the array plate 101. The light sensor 105 corresponds to an example of a detection unit configured to acquire optical information.

A piston-crank mechanism 106 moves the light directing unit 104 along a plane perpendicular to an optical axis of the lens of the light directing unit 104 or an optical axis of the excitation light. Specifically, the piston-crank mechanism 106 causes the light directing unit 104 to reciprocate along a short side direction of the array plate 101. As the light directing unit 104 reciprocates, excitation light from the light source 102 is scanned in the short side direction of the array plate 101. It should be noted that the short side direction of the array plate 101 is referred to as a main scanning direction, and reciprocal scanning by the piston-crank mechanism 106 is referred to as main scanning. In other words, the main scanning direction is a direction parallel to the short side of the array plate 101. In the present embodiment, the stroke of the main scanning is approximately 30 mm. It should be noted that an operation direction of the light directing unit 104 is constrained to the main scanning direction by a guide (not illustrated).

A pulse motor 107 causes the piston-crank mechanism 106 to rotate at high speed. In the present embodiment, the rotation speed of the pulse motor 107 is approximately 1200 rpm. The pulse motor 107 corresponds to an example of a driving unit.

An encoder 108 measures the position of the light directing unit 104 in the main scanning direction. The encoder 108 is installed on the piston-crank mechanism 106 and outputs a phase-difference pulse voltage consisting of phases A, B, and Z based on the position of the light directing unit 104 in the main scanning direction. The encoder 108 corresponds to an example of a measurement unit.

A linear stage 109 moves the array plate 101 along the plane perpendicular to the optical axis of the lens of the light directing unit 104 or the optical axis of the excitation light. Specifically, the linear stage 109 moves the array plate 101 in a direction perpendicular to the main scanning in a horizontal plane. The linear stage 109 is composed of a ball screw and an origin sensor. It should be noted that scanning in the direction perpendicular to the main scanning in the horizontal plane is referred to as sub-scanning. In other words, sub-scanning direction is a direction parallel to a long side of the array plate 101. There is a placement portion on the linear stage 109 for placing the array plate 101. A user places the array plate 101 on the placement portion in advance.

A pulse motor 110 is connected to the linear stage 109. The rotational motion of the pulse motor 110 is converted into linear motion by the ball screw of the linear stage 109.

It should be noted that the piston-crank mechanism 106, the pulse motor 107, the linear stage 109, and the pulse motor 110 correspond to an example of a scanning unit.

A motor driver 111 is a driver circuit for rotating the pulse motor 110. In the present embodiment, inputting a one-pulse signal to the motor driver 111 rotates the pulse motor 110 by 0.720 and moves the array plate 101 by 2 um in sub-scanning direction.

A linear stage 112 moves the array plate 101 in a vertical direction along the optical axis direction of the lens of the light directing unit 104 or the optical axis direction of the excitation light. The linear stage 112 is composed of a ball screw and an origin sensor. It should be noted that scanning in the vertical direction is referred to as height scanning.

A pulse motor 113 is connected to the linear stage 112. The rotational motion of the pulse motor 113 is converted into linear motion by the ball screw of the linear stage 112.

The linear stage 112 and the pulse motor 113 correspond to an example of an adjustment unit.

A motor driver 114 is a driver circuit for rotating the pulse motor 113. In the present embodiment, inputting a one-pulse signal to the motor driver 114 rotates the pulse motor 113 by 0.720 and moves the array plate 101 by 1 um upward, that is, in the vertical direction.

A motor driver 115 is a driver circuit for rotating the pulse motor 107. In the present embodiment, inputting a one-pulse signal to the motor driver 115 rotates the pulse motor 107 by 0.72° and moves the light directing unit 104 along the main scanning direction.

A controller 116 controls the entire specimen measurement apparatus 100. The controller 116 is composed of a field programmable gate array (FPGA), a central processing unit (CPU), and a memory and functions as a computer. The controller 116 performs main scanning, sub-scanning, and height scanning of excitation light on the array plate 101 by controlling the light source 102, the motor driver 111, the motor driver 114, and the motor driver 115. Further, while scanning, the controller 116 acquires fluorescence signal data (two-dimensional image) based on position information about the light directing unit 104 measured by the encoder 108 and an output signal from the light sensor 105 and stores the acquired fluorescence signal data (two-dimensional image) in an internal memory.

The controller 116 acquires height information and tilt information about the array plate 101 and generates drive pulse sequences output to the motor drivers 111 and 114 during sub-scanning and height scanning, as described below. Further, the controller 116 controls the timings of sub-scanning and height scanning and the timing of fluorescence signal data acquisition in synchronization with the position information about the light directing unit 104. By performing the foregoing control, the thickness and tilt of the array plate 101 are corrected in a case where the light directing unit 104 is outside an imaging region on the array plate 101, making it possible to perform height scanning so that the entire surface of the array plate 101 is in focus.

A user interface 117 is an interface for receiving an instruction from the user and displaying a result. The user interface 117 is composed of a keyboard, a mouse, and a display.

The controller 116 can receive an imaging instruction from the user via the user interface 117 and present image data based on fluorescence signal data to the user via the user interface 117. Further, the user can specify the imaging region, pixel pitch in the main scanning direction, and pixel pitch in the sub-scanning direction via a graphical user interface (GUI) on the user interface 117 during imaging.

The piston-crank mechanism 106 includes a crank 118 and a connecting rod 119.

The crank 118 is connected to a rotary shaft of the pulse motor 107 and the connecting rod 119 through a joint. The crank 118 has a length r.

The connecting rod 119 is connected to the crank 118 and the light directing unit 104 through a joint. The connecting rod 119 has a length 1.

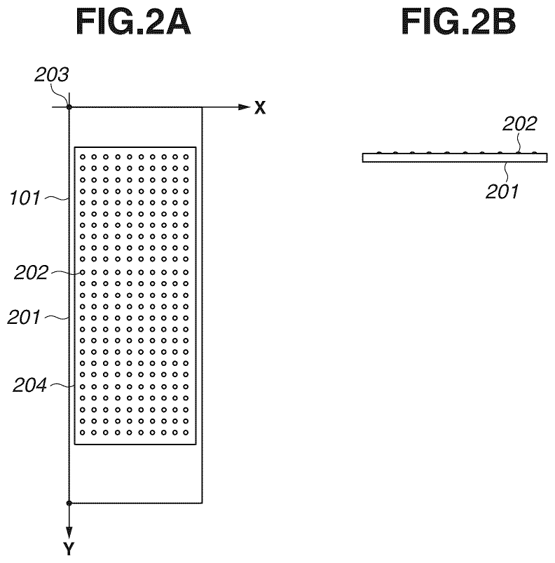

FIG. 2A is a diagram illustrating the array plate 101 viewed from above, and FIG. 2B is a diagram illustrating the array plate 101 viewed from the side.

The array plate 101 is composed of a glass slide 201 having a rectangular shape with short and long sides and a number of spots 202 arranged on an upper surface. At each spot 202, a biomolecule containing a peptide bond is immobilized. Here, a single type of biomolecule is immobilized at a single spot 202.

In the present embodiment, the diameter of each spot 202 is approximately 100 um, and the spot spacing is 200 um. Further, the array plate 101 has a length of 25 mm in the short side direction (short side) and 75 mm in the long side direction (long side). A point 203 at the upper left of the array plate 101 is defined as an origin, the rightward direction in the short side direction is defined as the positive direction of the X-axis, and the downward direction in the long side direction is defined as the positive direction of the Y-axis. Assuming that the X- and Y-coordinates are in units of um, the coordinates of the four corners of the array plate 101 are (0, 0), (25000, 0), (0, 75000), and (25000, 75000).

In the present embodiment, the stroke of the piston-crank mechanism 106 is 30 mm, which is longer by 5 mm than the length of the array plate 101. In other words, in main scanning, an additional 2.5 mm is scanned on both the left and right sides of the array plate 101, with the X-coordinate of the scanning range extending from −2500 to 27500.

The glass slide 201 includes a region where the spots 202 exist and a region where no spots 202 exist, due to limitations in spot generation or considerations for user grip. A region 204 is a region where the spots 202 on the glass slide 201 exist. In the present embodiment, the coordinates of the four corners of the region 204 are (2000, 2000), (23000, 2000), (2000, 65000), and (23000, 65000). The user can specify the range of Y-coordinates for sub-scanning.

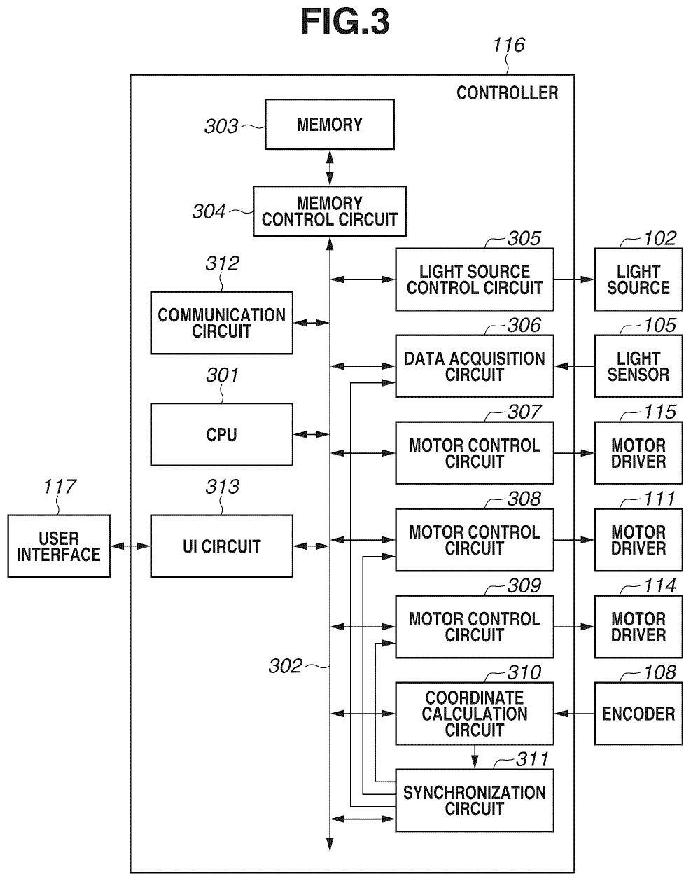

FIG. 3 is a block diagram illustrating an internal configuration of the controller 116 according to the first embodiment.

A CPU 301 executes software (program) configured to control the entire controller 116. The CPU 301 is composed of a micro-processor and a cache memory. The CPU 301 corresponds to an example of a control unit.

A bus interface 302 is an interface for connecting the CPU 301 to various peripheral circuits.

A memory 303 stores an imaging condition input by the user, a parameter of the specimen measurement apparatus 100, and the fluorescence signal data. The memory 303 can use a double data rate 4 synchronous dynamic random access memory (DDR4-SDRAM) and/or a solid state drive (SSD). The memory corresponds to an example of a storage unit.

A memory control circuit 304 controls the memory 303 based on a command to access the memory 303 via the bus interface 302.

A light source control circuit 305 is a control circuit through which the CPU 301 controls the light source 102. The light source control circuit 305 is composed of an interface conversion circuit and a digital-to-analog (DA) converter. The CPU 301 can control the on/off state and the light intensity of the laser irradiation from the light source 102 via the light source control circuit 305.

A data acquisition circuit 306 is a circuit configured to acquire fluorescence signal data based on the output signal from the light sensor 105 and the position of the light directing unit 104 relative to the array plate 101 and continuously store the acquired fluorescence signal data in the memory 303 based on an instruction from the CPU 301. The data acquisition circuit 306 is composed of a buffer circuit, an analog-to-digital (AD) converter, an AD converter control circuit, and a direct memory access (DMA) controller. The data acquisition circuit 306 corresponds to an example of an image acquisition unit.

A motor control circuit 307 generates a control signal to the motor driver 115 for the pulse motor 107, which is a main scanning motor, based on an instruction from the CPU 301. The motor control circuit 307 generates a drive pulse voltage based on an instruction from the CPU 301 regarding the rotational speed, acceleration, displacement, rotation direction, and rotation start timing of the pulse motor 107.

A motor control circuit 308 generates a control signal to the motor driver 111 for the pulse motor 110, which is a sub-scanning motor, based on an instruction from the CPU 301. The motor control circuit 308 generates a drive pulse voltage based on an instruction from the CPU 301 regarding the rotational speed, acceleration, displacement, rotation direction, and rotation start timing of the pulse motor 110.

A motor control circuit 309 generates a control signal to the motor driver 114 for the pulse motor 113, which is a height scanning motor, based on an instruction from the CPU 301. The motor control circuit 309 generates a drive pulse voltage based on an instruction from the CPU 301 regarding the rotational speed, acceleration, displacement, rotation direction, and rotation start timing of the pulse motor 113.

A coordinate calculation circuit 310 counts phase-difference pulse signals of the two phases A and B from the encoder 108 and calculates the position of the light directing unit 104. In the present embodiment, the encoder 108 has a resolution of 1 um. In a case where either the phase-A signal or the phase-B signal changes in level and the phase-A signal is ahead in phase compared to the phase-B signal, the coordinate calculation circuit 310 increases the coordinates of the light directing unit 104 by 1 um. Further, in a case where either the phase-A signal or the phase-B signal changes in level and the phase-B signal is ahead in phase compared to the phase-A signal, the coordinate calculation circuit 310 decreases the coordinates of the light directing unit 104 by 1 um.

A synchronization circuit 311 generates trigger signals to the data acquisition circuit 306, the motor control circuit 308, and the motor control circuit 309 based on coordinate information calculated by the coordinate calculation circuit 310. Here, the trigger signal to the data acquisition circuit 306 is referred to as a data acquisition trigger signal, the trigger signal to the motor control circuit 308 is referred to as a sub-scanning trigger signal, and the trigger signal to the motor control circuit 309 is referred to as a height scanning trigger signal.

Upon receiving the data acquisition trigger signal, the data acquisition circuit 306 controls an internal AD converter, acquires a single piece of data output by the light sensor 105, and stores the acquired output data in the memory 303 via the internal DMA controller.

Upon receiving the sub-scanning trigger signal, the motor control circuit 308 outputs a drive pulse sequence corresponding to the displacement of the pixel pitch in the sub-scanning direction to the motor driver 111. The pixel pitch in the sub-scanning direction is specified by the user at the start of imaging and stored in the memory 303.

Upon receiving the height scanning trigger signal, the motor control circuit 309 outputs a drive pulse sequence corresponding to the displacement in the height scanning direction to the motor driver 114. The displacement in the height scanning direction is calculated by the CPU 301. A calculation method will be described below.

A communication circuit 312 is a circuit for connecting the specimen measurement apparatus 100 to an external network. A communication method using a communication protocol conforming to the Ethernet standard is employed. Connecting the specimen measurement apparatus 100 to an external personal computer (external PC) or an external server enables remote control of imaging and data storage in external high-capacity storage.

A user interface (UI) circuit 313 is a circuit for connecting the specimen measurement apparatus 100 to the user interface 117. The UI circuit 313 is composed of an input circuit from the keyboard and the mouse and an image forming circuit for controlling the display.

It should be noted that the peripheral circuits that constitute the controller 116 are implemented on a semiconductor chip, such as a FPGA or an ASIC, and operate in synchronization with the clock. In the present embodiment, the clock frequency is 100 MHz.

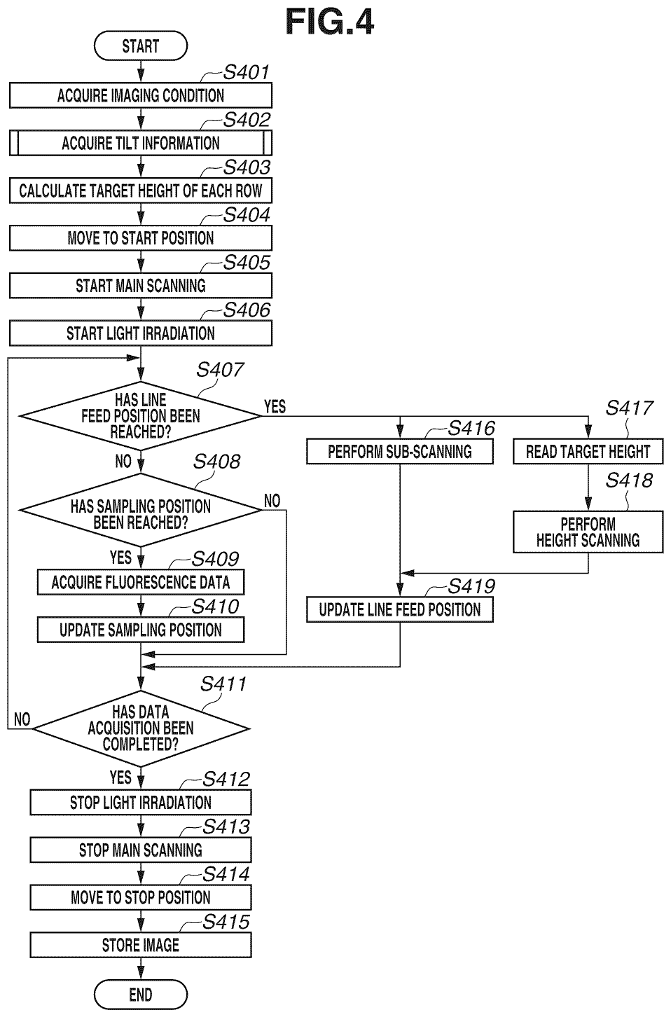

FIG. 4 is a flowchart illustrating operations in an imaging process performed by the specimen measurement apparatus 100 according to the first embodiment. The flowchart in FIG. 4 is realized by the CPU 301 of the controller 116 executing the program.

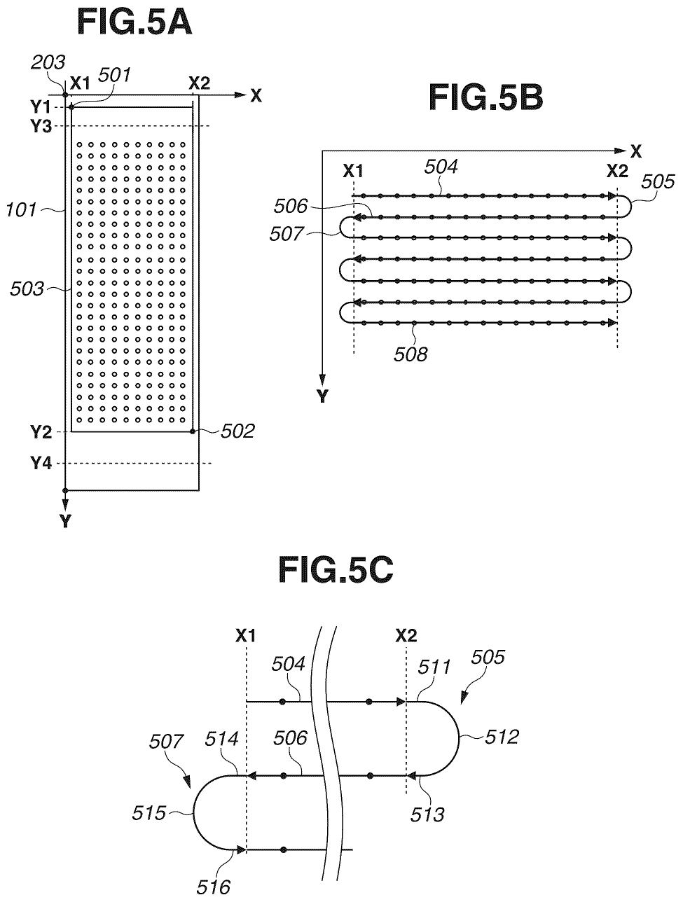

FIGS. 5A to 5C are diagrams illustrating the positional relationship of sub-scanning on the array plate 101 in the imaging process, as well as the array plate 101 as viewed from above.

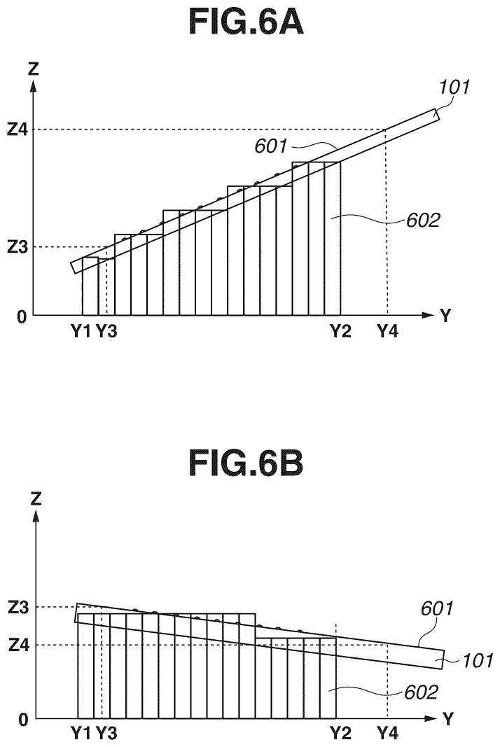

FIGS. 6A and 6B are diagrams illustrating the positional relationship of height scanning on the array plate 101 in the imaging process, as well as the array plate 101 as viewed from the side (long side). The Z=0 position on the vertical axis represents the horizontal reference plane. FIGS. 6A and 6B differ in the thickness and tilt of the placed array plates.

In S401, the CPU 301 reads an imaging condition based on an imaging instruction from the user. The user inputs the imaging condition in advance via the user interface 117. The CPU 301 stores the acquired imaging condition in the memory 303. Here, points 501 (X1, Y1) and 502 (X2, Y2) indicating the imaging region on the array plate 101, a pixel pitch Xp in the main scanning direction, a pixel pitch Yp in the sub-scanning direction, and a rotational speed Xs in the main scanning direction are input as imaging conditions. In the present embodiment, X1=500, X2=22500, Y1=500, Y2=64500, Xp=10 um, Yp=10 um, and Xs=1200 rpm. The memory 303 is, in other words, a storage unit configured to store information about the imaging region defined with respect to the surface (one surface) of the array plate 101 that includes the plurality of spots 202.

The CPU 301 sets the imaging condition in the synchronization circuit 311. Here, the rectangular region with the points 501 and 502 as diagonals on the array plate 101 is referred to as an imaging region 503. Further, the CPU 301 calculates the number of pixels Nx=(X2−X1)/Xp in the main scanning direction and the number of pixels Ny=(Y2−Y1)/Yp in the sub-scanning direction. In the present embodiment, Nx=2200, and Ny=6400.

In S402, the CPU 301 acquires height information about the array plate 101 and acquires tilt information based on the height information. The CPU 301 corresponds to an example of an acquisition unit. The tilt information corresponds to an example of information about the array plate. The height from the horizontal reference plane to the front surface of the array plate 101, i.e., the surface with the spots 202, is referred to as height information. Further, the tilt of the array plate 101 in the sub-scanning direction relative to the horizontal reference plane is referred to as tilt information. Here, the CPU 301 acquires height information Z3 and Z4 for two Y-coordinates Y3 and Y4 through measurement. In the present embodiment, Y3=750, and Y4=65000.

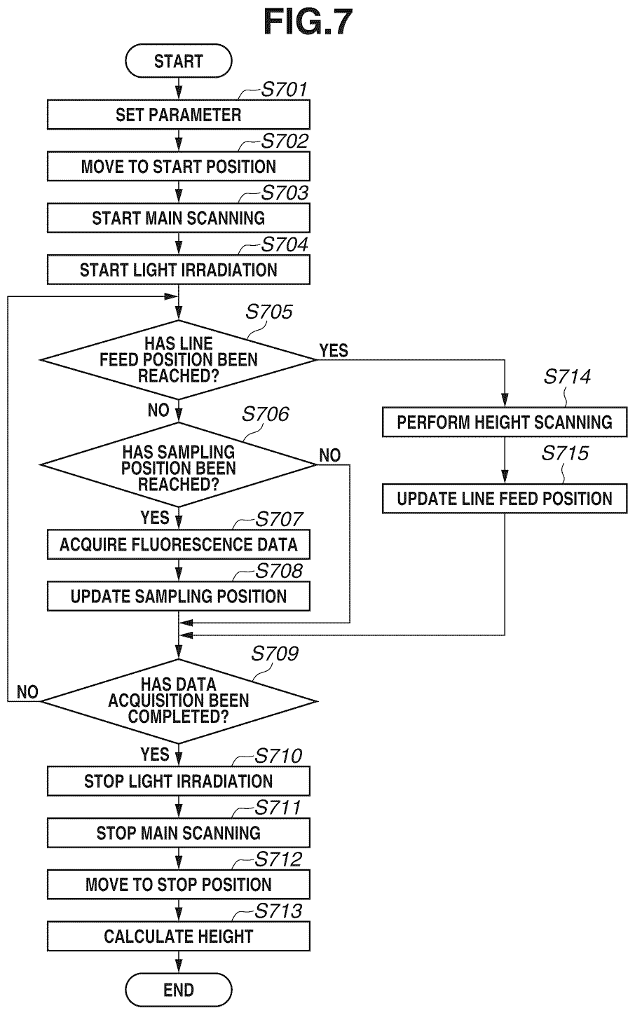

In a case where the tilt is as illustrated in FIG. 6A, Z4>Z3, whereas in a case where the tilt is as illustrated in FIG. 6B, Z3<Z4. A height information acquisition method will be described below with reference to a flowchart illustrated in FIG. 7.

Tilt information K is calculated using the following (equation 1):

$$K = ( Z 4 - Z 3 ) / ( Y 4 - Y 3 ) . \qquad ( equation l )$$

In S403, the CPU 301 calculates a target height of a sub-scanning position (each row) from the reference plane based on the imaging condition, the height information, and the tilt information K. Here, a target height Z(Y) of a sub-scanning position at a coordinate Y is given by the following (equation 2):

$$Z ( Y ) = K \times ( Y - Y 3 ) + Z 3 . \qquad ( equation 2 )$$

In FIGS. 6A and 6B, a target height 601 corresponds to the Z-coordinate of the front surface of the array plate 101.

In S404, the CPU 301 instructs the motor control circuits 307, 308, and 309 to move the array plate 101 and the light directing unit 104 to an imaging start position.

In the present embodiment, the X-coordinate of the imaging start position is at the end of the scanning range of the piston-crank mechanism 106, and the X-coordinate value is −2500. The Y-coordinate of the imaging start position is Y1 specified by the imaging condition. Further, a Z-coordinate Z1 of the imaging start position is calculated using Z(Y1) in (equation 1).

In S405, the CPU 301 starts main scanning to move the light directing unit 104 in the main scanning direction (scanning process). Specifically, the CPU 301 instructs the motor control circuit 307 to rotate the pulse motor 107 at the rotational speed Xs. As the pulse motor 107 is rotated, the light directing unit 104 starts reciprocating in the X-direction. The X-coordinate of the light directing unit 104 is calculated for each clock by the encoder 108 and the coordinate calculation circuit 310 and output to the synchronization circuit 311.

In S406, the CPU 301 instructs the light source control circuit 305 to cause the light source 102 to start light emission. As the light source 102 emits light, irradiation of the array plate 101 begins through the light directing unit 104.

In S407, the synchronization circuit 311 determines whether the light directing unit 104 has reached a line feed position. In a case where the X-coordinate of the light directing unit 104 output from the coordinate calculation circuit 310 moves from the imaging region to outside the imaging region, the synchronization circuit 311 determines that the light directing unit 104 has reached the line feed position. In a case where the current main scanning direction is a forward direction (direction in which the X-coordinate increases), when the X-coordinate of the light directing unit 104 exceeds X2, the light directing unit 104 is determined to have reached the line feed position. Scanning in the forward direction is represented by a trajectory 504 in FIG. 5B. On the other hand, in a case where the current main scanning direction is a return direction (direction in which the X-coordinate decreases), when the X-coordinate of the light directing unit 104 becomes less than X1, the synchronization circuit 311 determines that the light directing unit 104 has reached the line feed position. Scanning in the return direction is represented by a trajectory 506 in FIG. 5B. The initial value of the main scanning direction is the forward direction, and thereafter, the return direction and the forward direction alternate each time the line feed position is reached.

In a case where the line feed position has been reached, the synchronization circuit 311 outputs the sub-scanning trigger signal and the height scanning trigger signal to execute S416 in parallel with S417 and S418. In a case where the line feed position has not been reached, the synchronization circuit 311 outputs neither the sub-scanning trigger signal nor the height scanning trigger signal, and the processing proceeds to S408.

In S408, the synchronization circuit 311 determines whether the light directing unit 104 has reached a sampling position. The sampling position refers to the point on the array plate 101 where fluorescence signal data is acquired. It should be noted that while a case where the sampling position is a position different from the spots is described, the sampling position may be the same position as a spot. An X-coordinate P(N) of the Nth sampling position is expressed by the following (equation 3):

$$P ( N ) = X 1 + Xp \times ( N + 1 / 2 ) ( N = 0 , 1 , … , Nx - 1 ) . \qquad ( equation 3 )$$

The sampling position refers to a plurality of points on a trajectory, such as a point 508 in FIG. 5B, and the pitches in the X- and Y-directions are respectively Xp and Yp. Further, the initial value of the sampling position is P(0) and stored in the synchronization circuit 311. In the first sampling position determination, the light directing unit 104 is determined to have reached the sampling position in a case where the X-coordinate of the light directing unit 104 output from the coordinate calculation circuit 310 has passed P(0) in the forward direction (direction in which the X-coordinate increases). In the second and following sampling position determinations, the light directing unit 104 is determined to have reached the sampling position in a case where the X-coordinate of the light directing unit 104 output from the coordinate calculation circuit 310 has passed the sampling position updated in S410 described below.

In a case where the sampling position has been reached, the synchronization circuit 311 outputs the data acquisition trigger signal, and the processing proceeds to S409. In a case where the sampling position has not been reached yet, the synchronization circuit 311 does not output the data acquisition trigger signal, and the processing proceeds to S411.

In S409, the data acquisition circuit 306 acquires optical information from the sampling position. Specifically, the data acquisition circuit 306 outputs a conversion start signal of the internal AD converter and performs AD conversion of an output voltage from the light sensor 105. The AD-converted fluorescence signal data is stored in the memory 303 via the internal DMA controller of the data acquisition circuit 306 and the memory control circuit 304. After Nx×Ny pieces of data are stored in the memory 303, the data acquisition circuit 306 sets an internal data acquisition complete register to “1”, whereas in a case where Nx×Ny pieces of data are not stored in the memory 303, the data acquisition circuit 306 sets the internal data acquisition complete register to “0”. The process of S409 is performed while the light directing unit 104 reciprocates in the main scanning direction, but is not performed while the light directing unit 104 reciprocates in the sub-scanning direction.

In S410, the synchronization circuit 311 updates the sampling position internally stored. In a case where the current main scanning direction is the forward direction (direction in which the X-coordinate increases), the synchronization circuit 311 updates the sampling position P(N) to P(N+1), whereas in a case where the current main scanning direction is the return direction (direction in which the X-coordinate decreases), the synchronization circuit 311 updates the sampling position P(N) to P(N−1).

In S411, the CPU 301 determines whether data acquisition has been completed. The CPU 301 reads the data acquisition complete register of the data acquisition circuit 306, and in a case where the value of the data acquisition complete register is 1, the CPU 301 determines that data acquisition has been completed, and the processing proceeds to S412. In a case where the value of the data acquisition complete register is 0, the CPU 301 determines that data acquisition has not been completed, and the processing proceeds to S407.

In S412, the CPU 301 instructs the light source control circuit 305 to stop the emission of light from the light source 102. As the light source 102 stops emitting light, irradiation of the array plate 101 through the light directing unit 104 stops.

In S413, the CPU 301 stops main scanning. Specifically, the CPU 301 instructs the motor control circuit 307 to stop the rotation of the pulse motor 107. As the rotation of the pulse motor 107 stops, the reciprocation of the light directing unit 104 in the X-direction stops.

In S414, the CPU 301 instructs the motor control circuits 307, 308, and 309 to move the array plate 101 and the light directing unit 104 to a stop position. The X-, Y-, and Z-coordinates of the stop position are 0. The movement to the stop position is performed by returning each axis to the origin using a Z-phase pulse signal of the encoder 108, an origin sensor signal in the linear stage 109, and an origin sensor signal of the linear stage 112.

In S415, the CPU 301 reads the Nx×Ny pieces of fluorescence signal data stored in the memory 303, performs data compression and format conversion processing, and generates a fluorescence image file in Tagged Image File Format (TIFF). The fluorescence image file is stored in the memory 303 and presented to the user via the UI circuit 313 and the user interface 117. Further, it is transferred to an external data server via the communication circuit 312 based on an instruction from the user.

In S416, the CPU 301 performs sub-scanning to move the array plate 101 in the sub-scanning direction (scanning process). Specifically, the CPU 301 instructs the motor control circuit 308 to move the array plate 101 by Yp in the sub-scanning direction. Here, the number of pulses output to the motor driver 111 by the motor control circuit 308 is Yp/My, where My is the displacement of the array plate 101 when one pulse of a voltage pulse signal is transmitted to the motor driver 111. In the present embodiment, My=2 um. Sub-scanning is represented by trajectories 505 and 507 in FIG. 5B, and the movement distance in the Y-direction is Yp.

FIG. 5C is an enlarged view of the trajectories 505 and 507. The trajectory 505 includes a linear trajectory 511 along the forward direction of the main scanning direction, a semicircular trajectory 512, and a linear trajectory 513 along the return direction of the main scanning direction. Further, the trajectory 507 includes a linear trajectory 514 along the return direction of the main scanning direction, a semicircular trajectory 515, and a linear trajectory 513 along the forward direction of the main scanning direction. As described above, the trajectories 505 and 507 in the present embodiment each include trajectories corresponding to at least two movement directions.

Based on an instruction from the CPU 301, the motor control circuit 308 outputs a pulse signal to the motor driver 111 at a speed that allows sub-scanning to complete while the light directing unit 104 is outside the imaging region in the main scanning direction.

In S417, the CPU 301 reads the target heights before and after sub-scanning from the memory 303 to perform height scanning. Specifically, the CPU 301 reads Z(Y+Yp) and Z(Y) and calculates the displacement in height scanning. The displacement in height scanning varies depending on the current Y-coordinate, but the number of output pulses and the rotation direction of the pulse motor 113 are calculated so that the height in the Z-direction after movement is closest to the target height Z(Y+Yp) at the Y-coordinate after sub-scanning in S416.

A specific calculation direction will be described below.

Here, the displacement of the array plate 101 when one pulse of a voltage pulse signal is transmitted to the motor driver 114 is denoted as Mz. In the present embodiment, Mz=1 um.

RoundMz(x) denotes the multiple of Mz closest to a number x, ABS(x) denotes the absolute value of a number, and Sign(x) denotes the sign of a number. The multiple of Mz closest to the target height is referred to as the target number of pulses. The target number of pulses takes discrete values and corresponds to a height 602 in FIGS. 6A and 6B. The number of pulses output to the motor driver 114 by the motor control circuit 309 is expressed by the following (equation 4):

$$Zp = ABS ( Round Mz ( Z ( Y + Y p ) ) - Round Mz ( Z ( Y ) ) ) . \qquad ( equation 4 )$$

RoundMz(Z(Y)) takes discrete values close to the front surface of the array plate 101 as specified by the height 602 in FIGS. 6A and 6B.

Further, a movement direction Dir of the array plate in the height direction is expressed by the following (equation 5):

$$Dir = Sign ( Round Mz ( Z ( Y + Y p ) ) - Round Mz ( Z ( Y ) ) ) . \qquad ( equation 5 )$$

The positive direction of Dir is defined as vertically upward, in the direction in which the distance between the light directing unit 104 and the array plate 101 increases. In a case where the tilt of the array plate 101 is as illustrated in FIG. 6A, the value of Dir is 1, whereas in a case where the tilt of the array plate 101 is as illustrated in FIG. 6B, the value of Dir is −1.

In S418, the CPU 301 performs height scanning to adjust the array plate 101 along the vertical direction in order to acquire in-focus optical information (adjustment process). Specifically, the CPU 301 instructs the motor control circuit 309 to move the array plate 101 by Zp in the movement direction Dir. In a case where the value of Dir is positive, the array plate 101 is moved upward, whereas in a case where the value of Dir is negative, the array plate 101 is moved downward. The process of S418 is performed based on scanning sequence information indicating that the light directing unit 104 has reached the line feed position in S407. In other words, the CPU 301 determines whether to perform height scanning based on the scanning sequence information.

The number of pulses output to the motor driver 111 by the motor control circuit 309 is Zp/Mz. Based on an instruction from the CPU 301, the motor control circuit 309 outputs a pulse signal to the motor driver 114 at a speed that allows height scanning to complete while the light directing unit 104 is outside the imaging region in the main scanning direction. Thus, height scanning is performed during the sub-scanning period. In other words, height scanning and sub-scanning are performed in parallel. On the other hand, height scanning is not performed during the main scanning period.

In a case where sub-scanning in S416 and height scanning in S418 are complete, the processing proceeds to S419.

In S419, the synchronization circuit 311 updates the current main scanning direction and the Y-coordinate. In other words, in a case where the previous main scanning direction is the forward direction, the synchronization circuit 311 updates the main scanning direction to the return direction and the line feed position to X1. On the other hand, in a case where the previous main scanning direction is the return direction, the synchronization circuit 311 updates the main scanning direction to the forward direction and the line feed position to X2. Further, the synchronization circuit 311 increments the previous Y-coordinate by Yp to update the current Y-coordinate, and the processing proceeds to S411.

FIG. 7 is a flowchart illustrating operations in acquiring height information about the array plate 101, which corresponds to part of the process of S402 described above. It should be noted that in the process illustrated in the flowchart in FIG. 7, unlike the process illustrated in the flowchart in FIG. 4, reflected light signal data is acquired and analyzed while height scanning is performed at equal pitch intervals without performing sub-scanning, and the height of the front surface of the array plate 101 is calculated.

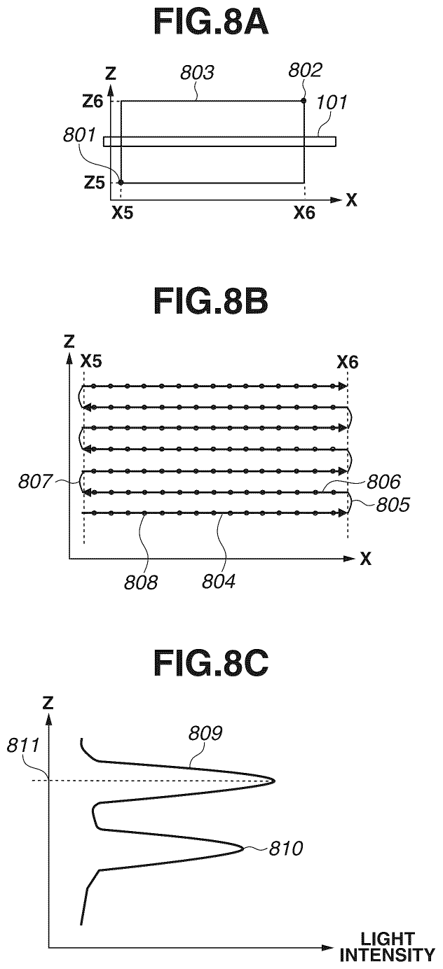

FIGS. 8A and 8B are diagrams illustrating positional relationships of height scanning on the array plate 101 in an operation of acquiring height information, as well as the array plate 101 as viewed from the side (short side). FIG. 8C plots, for each height, the intensity of reflected light acquired by the light sensor 105 during height scanning, with the horizontal axis representing the magnitude of the light intensity and the vertical axis representing the acquired height.

In S701, the CPU 301 sets a parameter for height information acquisition in the synchronization circuit 311. A Y-coordinate Yh of a position where height information acquisition is performed, the pixel pitch Xp in the main scanning direction, the pixel pitch Zp in the height scanning direction, points 801 (X5, Z5) and 802 (X6, Z6) indicating a height scanning range on the XZ-plane, and the rotational speed Xs in the main scanning direction are set as the parameters.

A rectangular region 803 with the points 801 and 802 as its diagonals on the XZ-plane is referred to as a height scanning region. The CPU 301 calculates the number of pixels Nx=(X6−X5)/Xp in the main scanning direction and the number of pixels Nz=(Z6−Z5)/Zp in the height scanning direction in advance. In the present embodiment, X5=500, X6=22500, Z5=2000, Z6=6000, Xp=10 [um], Zp=10 [um], and Xs=1200 [rpm]. In this case, Nx=2200, and Nz=400.

In S702, the CPU 301 instructs the motor control circuits 307, 308, and 309 to move the array plate 101 and the light directing unit 104 to a height information acquisition start position.

In the present embodiment, the X-coordinate of the height information acquisition start position is at the end of the scanning range of the piston-crank mechanism 106, and the X-coordinate value is −2500. The Y-coordinate of the height information acquisition start position is Yh, as specified by the parameter. Further, the Z-coordinate of the height information acquisition start position is Z5, as specified by the parameter.

In S703, the CPU 301 starts main scanning. This process is similar to the process ofS405 described above.

In S704, the CPU 301 causes the light source 102 to start light emission, thereby starting light irradiation. This process is similar to the process of S406 described above.

In S705, the synchronization circuit 311 determines whether the light directing unit 104 has reached the line feed position. In a case where the X-coordinate of the light directing unit 104 output from the coordinate calculation circuit 310 moves from the imaging region to outside the imaging region, the synchronization circuit 311 determines that the light directing unit 104 has reached the line feed position. In a case where the current main scanning direction is the forward direction (direction in which the X-coordinate increases), when the X-coordinate of the light directing unit 104 exceeds X6, the light directing unit 104 is determined to have reached the line feed position. Scanning in the forward direction is represented by a trajectory 804 in FIG. 8B. On the other hand, in a case where the current main scanning direction is the return direction (direction in which the X-coordinate decreases), when the X-coordinate of the light directing unit 104 becomes less than X5, the synchronization circuit 311 determines that the light directing unit 104 has reached the line feed position. Scanning in the return direction is represented by a trajectory 806 in FIG. 8B. The initial value of the main scanning direction is the forward direction, and thereafter, the return direction and the forward direction alternate each time the line feed position is reached.

In a case where the line feed position has been reached, the synchronization circuit 311 outputs the height scanning trigger signal, and the processing proceeds to S714. In a case where the line feed position has not been reached, the synchronization circuit 311 does not output the height scanning trigger signal, and the processing proceeds to S706.

In S706, the synchronization circuit 311 determines whether the light directing unit 104 has reached the sampling position. This process is similar to the process of S408 described above. The sampling position refers to a plurality of points on a trajectory, such as points 808 in FIG. 8B, and the pitches in the X- and Z-directions are respectively Xp and Zp. In a case where the sampling position has been reached, the synchronization circuit 311 outputs the data acquisition trigger signal, and the processing proceeds to S707. In a case where the sampling position has not been reached yet, the synchronization circuit 311 does not output the data acquisition trigger signal, and the processing proceeds to S709.

In S707, the data acquisition circuit 306 acquires reflected light signal data from the sampling position. This process is similar to the process of S409 described above. After Nx×Nz pieces of data are stored in the memory 303, the data acquisition circuit 306 sets the internal data acquisition complete register to “1”, whereas in a case where Nx×Nz pieces of data are not stored in the memory 303, the data acquisition circuit 306 sets the internal data acquisition complete register to “0”.

In S708, the synchronization circuit 311 updates the sampling position internally stored. This process is similar to the process of S410 described above.

In S709, the CPU 301 determines whether data acquisition has been completed. This process is similar to the process of S411 described above. In a case where the CPU 301 determines that data acquisition has been completed, the processing proceeds to S710. In a case where the CPU 301 determines that data acquisition has not been completed, the processing proceeds to S705.

In S710, the CPU 301 stops the emission of light from the light source 102. This process is similar to the process of S412 described above.

In S711, the CPU 301 stops main scanning. This process is similar to the process ofS413 described above.

In S712, the CPU 301 moves the array plate 101 and the light directing unit 104 to the stop position. This process is similar to the process of S414 described above.

In S713, the CPU 301 reads Nx×Nz pieces of reflected light signal data stored in the memory 303, analyzes the read data, and calculates height information about the array plate. Specifically, Nx pieces of data acquired at the same height are summed and then averaged to calculate the average light intensity for each height. When the average light intensities are arranged by Z-coordinate, two peaks corresponding to the front and back surfaces of the array plate 101 are present. In FIG. 8C, a peak 809 indicates a peak caused by the reflected light from the front surface of the array plate 101, and a peak 810 indicates a peak caused by the reflected light from the back surface of the array plate 101. A Z-coordinate 811 indicating the peak 809 with the greater Z-coordinate, i.e., the peak corresponding to the front surface, of the two peaks corresponds to height information at the position Yh.

In S714, the CPU 301 instructs the motor control circuit 309 to move the array plate 101 by Zp in the height scanning direction. The number of pulses output to the motor driver 114 by the motor control circuit 309 is Zp/Mz, where Mz is the displacement of the array plate 101 when one pulse of a voltage pulse signal is transmitted to the motor driver 114. Height scanning is represented by trajectories 805 and 807 in FIG. 8B, and the movement distance in the Z-direction is Zp.

Based on an instruction from the CPU 301, the motor control circuit 309 outputs a pulse signal to the motor driver 114 at a speed that allows height scanning to complete while the light directing unit 104 is outside the imaging region in the main scanning direction.

In S715, the synchronization circuit 311 updates the current main scanning direction and the Z-coordinate. In other words, in a case where the previous main scanning direction is the forward direction, the synchronization circuit 311 updates the main scanning direction to the return direction and the line feed position to X5. On the other hand, in a case where the previous main scanning direction is the return direction, the synchronization circuit 311 updates the main scanning direction to the forward direction and the line feed position to X6. Further, the synchronization circuit 311 increments the previous Z-coordinate by Zp to update the current Z-coordinate, and the processing proceeds to S709.

In acquiring tilt information in S402 described above, the process in the flowchart in FIG. 7 is performed on each of the Y-coordinates Y3 and Y4 to obtain height information Z3 for the Y-coordinate Y3 and height information Z4 for the Y-coordinate Y4, and the tilt information K is calculated using (equation 1). By calculating the tilt information K as described above, a target height can be calculated for each sub-scanning position in S403.

As described above, the specimen measurement apparatus 100 according to the present embodiment performs height scanning during the sub-scanning period to adjust the array plate 101 along the vertical direction. Thus, in-focus optical information can be acquired in a short time.

Further, in the present embodiment, the synchronization circuit 311 is used to perform sub-scanning and height scanning in synchronization with the position of the light directing unit 104. Since sub-scanning and height scanning are performed while the light directing unit 104 is outside the imaging region, it is unnecessary to move the array plate 101 in the imaging region. Therefore, the impact of vibrations caused by driving the array plate 101 can be reduced. Further, since the specimen measurement apparatus 100 does not include a high-speed servo control system composed of a high-performance focus sensor and a low-vibration actuator, a fluorescence image in focus across the entire surface of the array plate 101 can be acquired with a simple configuration.

Further, in the present embodiment, the pulse motor 107 for main scanning rotates at a constant speed during imaging to move the light directing unit 104, and sub-scanning and height scanning are performed while the light directing unit 104 is outside the imaging region. Since it is unnecessary to temporarily stop the pulse motor 107 for main scanning before sub-scanning and height scanning, the reciprocating scanning of the light directing unit 104 can be performed at high speed, which reduces the imaging time.

Further, in the present embodiment, two-dimensional scanning, involving both main scanning and sub-scanning, is performed while correcting individual differences in thickness and tilt of the entire array plate 101 based on height information and tilt information acquired at least at two points in advance. Thus, compared to three-dimensional scanning of the array plate 101, a fluorescence image in focus across the entire surface of the array plate 101 can be acquired in a short time.

Further, in the present embodiment, the target number of pulses closest to the target height is calculated for each sub-scanning position (each row). Therefore, in a case where the amount and direction of height scanning are not predetermined values, especially in a case where the displacement differs for each row, it is possible to adjust to a height close to the target height. Thus, even in a case where it is difficult to predict the height and tilt of the array plate 101 in advance due to individual differences in thickness and tilt of the array plate 101, and in the method of placing the array plate 101, a fluorescence image in focus across the entire surface of the array plate can be acquired.

Further, in the present embodiment, main scanning is also performed during height information acquisition, and Nx pieces of data are averaged, enabling stable peak detection even in a case where there is partial contamination or liquid on the array plate 101. Thus, the accuracy of the acquired height information can be improved compared to detecting a peak at a single point on the array plate 101 for each height scanning position.

Further, in the present embodiment, the synchronization circuit 311 is used to sample fluorescence signal data in synchronization with the position of the light directing unit 104. Compared to a case where data sampling and sub-scanning are performed at a constant interval without synchronizing with the position of the light directing unit 104, evenly spaced data can be acquired across the entire array plate 101, thereby improving positional accuracy in acquiring a captured image.

It should be noted that while the present embodiment describes the case where the imaging region 503 covers the entire region 204 and all spots on the array plate 101 are imaged, this is not a limiting case. For example, the user can set part of the region 204 as the imaging region 503. In this case, the imaging time can be reduced by scanning of only the part that includes the spot of interest to the user.

It should be noted that while the present embodiment describes the case where height information is acquired using the peak of the reflected light from the front surface of the glass slide 201, this is not a limiting case. For example, height information can be acquired using the peak position of the fluorescence signal luminance from some of the spots on the array plate 101. In this case, although the spots need to be irradiated with light to acquire height information, since the light sensor 105 does not need to acquire reflected light, the number of components in the optical system can be reduced.

It should be noted that while the present embodiment describes the case with a single wavelength form the light source 102, a plurality of light sources, a plurality of optical systems, and a plurality of light sensors for each wavelength may be included, and the array plate 101 may be irradiated with excitation light with a plurality of wavelengths. By comparing the fluorescence signals generated by the excitation light with the plurality of wavelengths, the properties of the biomolecule at the spot can be analyzed in more detail.

It should be noted that while the present embodiment describes the case where the light directing unit 104 is moved in the main scanning direction, this is not a limiting case. For example, the array plate 101 may be moved in the main scanning direction, or the light directing unit 104 and the array plate 101 may both be moved in the main scanning direction. In other words, at least one of the light directing unit 104 and the array plate 101 may be moved relative to the other in the main scanning direction.

Further, while the present embodiment describes the case where the array plate 101 is moved in the sub-scanning direction, this is not a limiting case. For example, the light directing unit 104 may be moved in the sub-scanning direction, or the light directing unit 104 and the array plate 101 may both be moved in the sub-scanning direction. In other words, at least one of the light directing unit 104 and the array plate 101 may be moved relative to the other in the sub-scanning direction.

Further, while the present embodiment describes the case where the array plate 101 is moved in the vertical direction, this is not a limiting case. For example, the light directing unit 104 may be moved in the vertical direction, or the light directing unit 104 and the array plate 101 may both be moved in the vertical direction. In other words, at least one of the light directing unit 104 and the array plate 101 may be moved relative to the other in the vertical direction to adjust the relative position of the light directing unit 104 and the array plate 101.

### Second Embodiment

A second embodiment differs from the first embodiment in the scanning method of the light directing unit 104 and the fluorescence signal data sampling method. In the first embodiment, signal acquisition from the light sensor 105 is performed in the forward and return directions of main scanning, and sub-scanning and height scanning are performed during outside the imaging region at both ends of the array plate 101. In the present embodiment, signal acquisition from the light sensor 105 is performed during main scanning in the forward direction, and sub-scanning and height scanning are performed during main scanning in the return direction.

It should be noted that the configuration of the specimen measurement apparatus 100 and the internal configurations of the array plate 101 and the controller 116 in the present embodiment are similar to those in FIGS. 1, 2A, 2B, and 3, so that the description of these will be omitted.

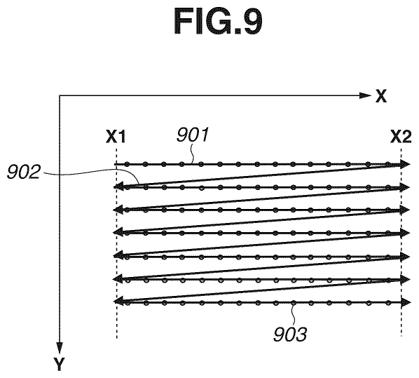

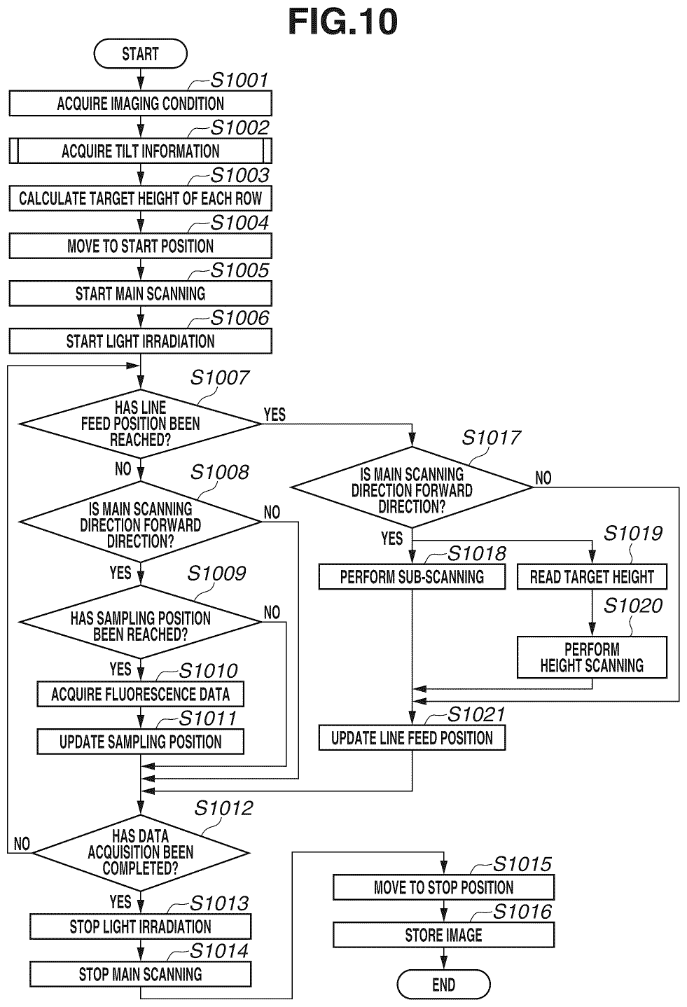

FIG. 9 is a diagram illustrating a positional relationship of sub-scanning on the array plate 101 in the imaging process. FIG. 10 is a flowchart illustrating an operation in a process of imaging the array plate 101 performed by the specimen measurement apparatus 100 according to the present embodiment.

S1001 to S1006 are similar to S401 to S406 in the first embodiment.

In S1007, the synchronization circuit 311 determines whether the light directing unit 104 has reached the line feed position. In a case where the X-coordinate of the light directing unit 104 output from the coordinate calculation circuit 310 moves from the imaging region to outside the imaging region, the synchronization circuit 311 determines that the light directing unit 104 has reached the line feed position. In a case where the current main scanning direction is the forward direction (direction in which the X-coordinate increases), when the X-coordinate of the light directing unit 104 exceeds X2, the light directing unit 104 is determined to have reached the line feed position. Scanning in the forward direction is represented by a trajectory 901 in FIG. 9. On the other hand, in a case where the current main scanning direction is the return direction (direction in which the X-coordinate decreases), when the X-coordinate of the light directing unit 104 becomes less than X1, the synchronization circuit 311 determines that the light directing unit 104 has reached the line feed position. Scanning in the return direction is represented by a trajectory 902 in FIG. 9. The initial value of the main scanning direction is the forward direction, and thereafter, the return direction and the forward direction alternate each time the line feed position is reached.

In a case where the line feed position has been reached, the processing proceeds to S1017. In a case where the line feed position has not been reached, the processing proceeds to S1008.

In S1008, the synchronization circuit 311 determines whether the current main scanning direction is the forward direction or the return direction. In a case where it is the forward direction, the processing proceeds to S1009. In a case where it is the return direction, the processing proceeds to S1012.

In S1009, the synchronization circuit 311 determines whether the light directing unit 104 has reached the sampling position. The sampling position refers to the point on the array plate 101 where fluorescence signal data is acquired. The X-coordinate P(N) of the Nth sampling position is expressed by (equation 3) described above. The sampling position refers to a plurality of points on a trajectory, such as points 903 in FIG. 9, and the pitches in the X- and Y-directions are respectively Xp and Yp, with the same coordinates as in the first embodiment. Further, the initial value of the sampling position is P(0) and stored in the synchronization circuit 311. In the first sampling position determination, the light directing unit 104 is determined to have reached the sampling position in a case where the X-coordinate of the light directing unit 104 output from the coordinate calculation circuit 310 has passed P(0) in the forward direction (direction in which the X-coordinate increases). In the second and following sampling position determinations, the light directing unit 104 is determined to have reached the sampling position in a case where the X-coordinate of the light directing unit 104 output from the coordinate calculation circuit 310 has passed in the forward direction the sampling position updated in S1011 described below.

In a case where the sampling position has been reached, the synchronization circuit 311 outputs the data acquisition trigger signal, and the processing proceeds to S1010. In a case where the sampling position has not been reached yet, the synchronization circuit 311 does not output the data acquisition trigger signal, and the processing proceeds to S1012.

S1010 is similar to the process of S409 in the first embodiment.

In S1011, the synchronization circuit 311 updates the sampling position internally stored. Since the current main scanning direction is the forward direction (direction in which the X-coordinate increases), the synchronization circuit 311 updates the sampling position P(N) to P(N+1). However, in a case where N=Nx−1, P(N) is updated to P(0).

S1012 to S1016 are similar to S411 to S415 in the first embodiment.

In S1017, the synchronization circuit 311 determines whether the current main scanning direction is the forward direction or the return direction. In a case where it is the forward direction, the synchronization circuit 311 outputs the sub-scanning trigger signal and the height scanning trigger signal to execute S1018 in parallel with S1019 and S1020. In a case where it is the return direction, the processing proceeds to S1021.

In S1018, the CPU 301 performs sub-scanning simultaneously with main scanning in the return direction. Specifically, the CPU 301 instructs the motor control circuit 308 to move the array plate 101 by Yp in the sub-scanning direction. Here, the number of pulses output to the motor driver 111 by the motor control circuit 308 is Yp/My, where My is the displacement of the array plate 101 when one pulse of a voltage pulse signal is transmitted to the motor driver 111. In the present embodiment, My=2 um.

Here, sub-scanning is performed simultaneously with main scanning in the return direction, resulting in a substantially linear inclined trajectory, such as the trajectory 902 in FIG. 9, that intersects both the X- and Y-directions. It should be noted that the movement distance of the component in the Y-direction is Yp.

Based on an instruction from the CPU 301, the motor control circuit 308 outputs a pulse signal to the motor driver 111 at a speed that allows sub-scanning to complete while the light directing unit 104 is moved in the return direction of the main scanning direction.

S1019 is similar to the process of S417 in the first embodiment.

In S1020, height scanning is performed to acquire in-focus optical information. Specifically, the CPU 301 instructs the motor control circuit 309 to move the array plate 101 by Zp in the movement direction Dir. In a case where the value of Dir is positive, the array plate 101 is moved upward, whereas in a case where the value of Dir is negative, the array plate 101 is moved downward.

The number of pulses output to the motor driver 111 by the motor control circuit 309 is Zp/Mz. Based on an instruction from the CPU 301, the motor control circuit 309 outputs a pulse signal to the motor driver 114 at a speed that allows height scanning to complete while the light directing unit 104 is moved in the return direction of the main scanning direction. Thus, height scanning is performed while sub-scanning is performed and while main scanning in the return direction is performed. In other words, height scanning is performed in parallel with sub-scanning and main scanning in the return direction. On the other hand, height scanning is not performed while main scanning in the forward direction is performed.

In a case where sub-scanning in S1018 and height scanning in S1020 are complete, the processing proceeds to S1021.

S1021 is similar to the process of S419 in the first embodiment.

As described above, the specimen measurement apparatus 100 according to the present embodiment acquires fluorescence signal data only during main scanning in the forward direction, and sub-scanning and height scanning are performed during main scanning in the return direction without acquiring fluorescence signal data. Thus, although the imaging time is doubled, since the main scanning direction during data acquisition can be aligned, the impact of position and angle errors of the light directing unit 104 in the forward and return paths can be reduced.

Further, in the present embodiment, since the time spent in main scanning in the return direction can be allocated to sub-scanning and height scanning, the speed of sub-scanning and height scanning can be reduced. Thus, the impact of residual vibrations caused by sub-scanning and height scanning can be reduced, which can improve the quality of the fluorescence image.

It should be noted that while the present embodiment describes the case where fluorescence signal data is acquired only during main scanning in the forward direction, fluorescence signal data may be acquired only during main scanning in the return direction, and sub-scanning and height scanning may be performed during main scanning in the forward direction without acquiring fluorescence signal data. This can be realized by reversing the forward and return directions in the determinations in S1008 and S1017 described above.

It should be noted that while the present embodiment describes the operation in the imaging process, sampling and height scanning can be performed only in one of the forward and return directions also in the process of acquiring height information. In this case, as in the imaging process, the impact of position and angle errors of the light directing unit 104 can be reduced, and the impact of residual vibrations caused by height scanning can also be reduced, which can improve the accuracy of the acquired height information.

### Third Embodiment

A third embodiment differs from the first embodiment in that the encoder 108 for measuring the position of the light directing unit 104 in the main scanning direction is not included. In the first embodiment, the coordinate calculation circuit 310 calculates the position of the light directing unit 104 based on a signal from the encoder 108. In the present embodiment, the position of the light directing unit 104 is calculated based on a motor drive pulse signal from the motor control circuit 307. It should be noted that the configuration of the specimen measurement apparatus 100 and the array plate 101 in the present embodiment are similar to those in FIGS. 1, 2A, and 2B, so that the description of these will be omitted.

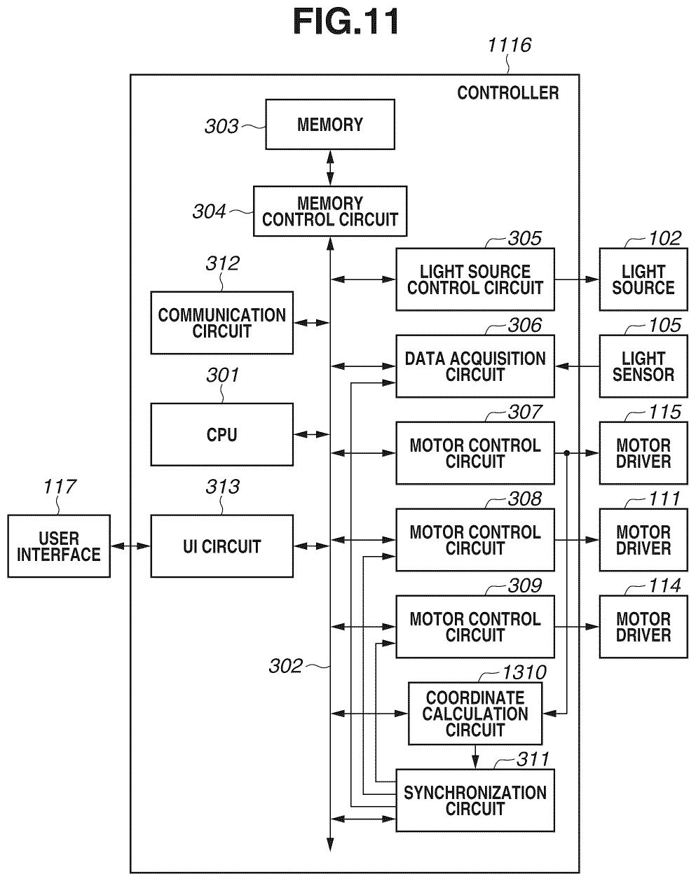

FIG. 11 is a block diagram illustrating an internal configuration of a controller 1116 in the third embodiment. The configuration of the controller 1116 is similar to that in the first embodiment, except that the coordinate calculation circuit 310 is replaced with a coordinate calculation circuit 1310 and the encoder 108 is not included.

The coordinate calculation circuit 1310 is a circuit that calculates the position of the light directing unit 104 based on the drive pulse voltage from the motor control circuit 307.

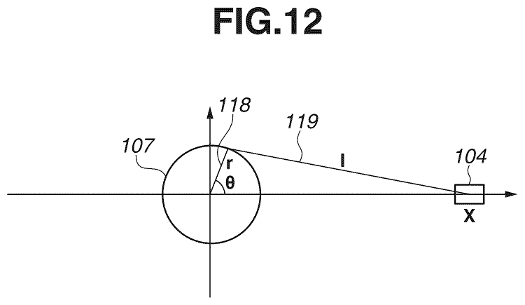

FIG. 12 is a diagram illustrating an operation of the piston-crank mechanism.

A position x of the light directing unit 104 is expressed by the following (equation 6), where r is the length of the crank 118 of the piston-crank mechanism, 1 is the length of the connecting rod 119 of the piston-crank mechanism, and θ is the angle of the pulse motor 107.

$$[ Math 1 ]$$

$$x = r cos θ + \sqrt{{l}^{2} - {r}^{2} {sin}^{2} θ} . \qquad ( equation 6 )$$

By multiplying the rotation angle per pulse by the number of drive pulses, θ can be calculated. Since r and 1 are known values, the coordinates of the light directing unit 104 are calculated using (equation 6) each time a drive pulse is input. However, since the rotation angle per pulse is 0.72° increments, the resulting value of x will also be discrete. Thus, the coordinate calculation circuit 1310 estimates a coordinate between pulses by interpolating using an angular velocity.

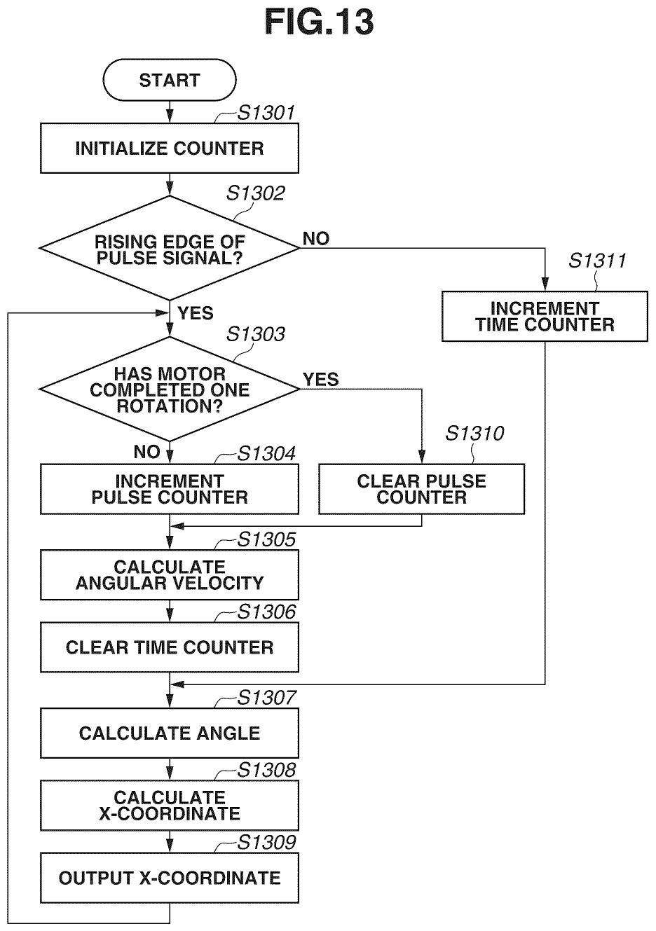

FIG. 13 is a flowchart illustrating an operation performed by the coordinate calculation circuit.

In S1301, the coordinate calculation circuit 1310 sets the values of an internal pulse counter and a time counter to 0.

In 51302, the coordinate calculation circuit 1310 determines whether a rising edge of the drive pulse signal from the motor control circuit 307 has been input. In a case where it has been input, the processing proceeds to S1303. In a case where it has not been input, the processing proceeds to S1311.

In S1303, the coordinate calculation circuit 1310 determines whether the motor has completed one rotation. For example, in a case where a rotation angle Op of the pulse motor 107 per pulse is 0.72°, the motor completes one full rotation with 500 pulses. Thus, in a case where a current value Cp of the pulse counter is 499, it is determined that one full rotation has been completed, and the processing proceeds to S1310. On the other hand, in a case where the current value Cp of the pulse counter is 498 or less, it is determined that one full rotation has not been completed, and the processing proceeds to S1304.

In S1304, the coordinate calculation circuit 1310 increments the pulse counter by 1.

In S1305, the coordinate calculation circuit 1310 calculates an angular velocity w by dividing the value of the time counter by a clock cycle. The angular velocity w is calculated using w=θp x T/Ct, where Ct is the value of the time counter, and T is the clock cycle. However, in a case where the value Ct of the time counter is 0, the angular velocity w is calculated to be 0.

In S1306, the coordinate calculation circuit 1310 sets the time counter to 0.

In S1307, the coordinate calculation circuit 1310 calculates an angle θ. The angle θ is calculated using θ=Cp×θp+w×Ct×T, where Cp is the value of the pulse counter.

In S1308, the coordinate calculation circuit 1310 calculates an x-coordinate. Specifically, the x-coordinate is calculated by substituting the calculated angle θ into (equation 6).

In S1309, the coordinate calculation circuit 1310 outputs the calculated coordinate to the synchronization circuit 311.

In S1310, the coordinate calculation circuit 1310 sets the time counter to 0.

In S1311, the coordinate calculation circuit 1310 increments the time counter by 1.

While the operation of the coordinate calculation circuit 1310 has been described with reference to the flowchart, since the coordinate calculation circuit 1310 is implemented on a digital circuit, the coordinate calculation circuit 1310 actually performs the operations of S1301 to S1311 at each clock cycle.

As described above, the present embodiment allows synchronization of main scanning, sub-scanning, height scanning, and data acquisition without using an encoder by estimating the position of the light directing unit 104 from the drive pulse signal from the motor control circuit 307. Since the specimen measurement apparatus 100 does not include an encoder, manufacturing costs can be reduced.

It should be noted that while the present embodiment describes the case where the rotation angle θp of the pulse motor 107 per pulse is set to 0.72°, this is not a limiting case. For example, by use of a motor driver with a microstep control function in the motor control circuit 307, θp can be divided into tens or hundreds of steps, thereby improving the accuracy of estimating the position of the light directing unit 104.

It should be noted that while the present embodiment describes the case where the coordinate calculation circuit 1310 calculates the angular velocity from the time difference between the rising edges of the pulse signal, this is not a limiting case. For example, the coordinate calculation circuit 1310 can be configured to operate while the pulse motor 107 rotates at a constant speed, and the angular velocity can be calculated using the rotational speed Xs in the main scanning direction specified by the user.

While the present invention has been described in detail based on its preferred embodiments, the present invention is not limited to the specific embodiments, and various forms that do not deviate from the essence of the invention are also included within the scope of the present invention. For example, a portion of the configuration or process from one embodiment may be combined with another embodiment.

Further, a single hardware component may perform the various types of control described as being performed by the CPU 301, the synchronization circuit 311, or the data acquisition circuit 306 in the embodiments described above. Further, a plurality of hardware components (e.g., a plurality of processors or circuits) may share the processes of the various types of control to control the entire apparatus.

### Other Embodiments

The present invention can also be realized by executing the following process. Specifically, a program configured to realize the function of the embodiments described above is supplied to a system or an apparatus via a network or various recording media, and a computer (such as a CPU or a microprocessor unit (MPU)) of the system or the apparatus reads the program codes and executes the read program codes. In this case, the program and the recording medium storing the program constitute the present invention.

Further, the disclosure of the present embodiment includes the following configurations.

### Configuration 1

A scanning apparatus configured to cause an observation optical system to scan over an array plate including a plurality of spots on one surface, the scanning apparatus including an observation optical system configured to radiate primary light toward the one surface to acquire optical information related to at least a portion of the plurality of spots, a scanning unit configured to perform main scanning in which the observation optical system moves relative to the array plate in a first direction and acquires the optical information and sub-scanning in which the observation optical system moves relative to the array plate in a second direction intersecting the first direction without acquiring the optical information, and an adjustment unit configured to adjust a position of the observation optical system relative to the array plate in an optical axis direction of the primary light, wherein the adjustment unit performs the adjustment in a case where the scanning unit is in a period of the sub-scanning.

### Configuration 2

The scanning apparatus according to Configuration 1, wherein in a case where the scanning unit is in a period of the main scanning, the adjustment unit does not perform the adjustment.

### Configuration 3

The scanning apparatus according to Configuration 1 or 2, further including an image acquisition unit configured to acquire a two-dimensional image based on an output signal from the observation optical system and information about a position of the observation optical system relative to the array plate on a plane on which the observation optical system moves relative to the array plate.

### Configuration 4

The scanning apparatus according to any one of Configurations 1 to 3, further including a control unit configured to determine whether to perform the adjustment based on information about a scanning sequence performed by the scanning unit.

### Configuration 5

The scanning apparatus according to any one of Configurations 1 to 4, further including a storage unit configured to store information about an imaging region defined with respect to the one surface.

### Configuration 6

The scanning apparatus according to any one of Configurations 1 to 5, wherein the sub-scanning includes movement corresponding to two or more movement directions on a plane on which the observation optical system moves relative to the array plate.

### Configuration 7

The scanning apparatus according to Configuration 6, wherein the sub-scanning includes movement in the first direction.

### Configuration 8

The scanning apparatus according to any one of Configurations 1 to 7, further including an acquisition unit configured to acquire information about the array plate, wherein the adjustment unit performs the adjustment based on the information about the array plate acquired by the acquisition unit.

### Configuration 9

The scanning apparatus according to Configuration 8, wherein the information about the array plate includes tilt information about the array plate as viewed from the first direction.

### Configuration 10

The scanning apparatus according to Configuration 9, wherein the tilt information about the array plate is calculated based on height information about the array plate acquired at least at two points.

### Configuration 11

The scanning apparatus according to any one of Configurations 1 to 10, wherein the scanning unit moves the observation optical system and the array plate relative to each other based on information about a position of the observation optical system and information about a position of the array plate.

### Configuration 12

The scanning apparatus according to any one of Configurations 1 to 11, wherein the adjustment unit performs the adjustment based on information about an imaging region from which the optical information is acquired and information about a position of the observation optical system.

### Configuration 13

The scanning apparatus according to Configuration 12, wherein in a case where the position of the observation optical system is outside the imaging region, the adjustment unit performs the adjustment.

### Configuration 14

The scanning apparatus according to Configuration 12 or 13, wherein the information about the imaging region is information input in advance by a user.

### Configuration 15

The scanning apparatus according to any one of Configurations 11 to 14, further including a measurement unit configured to measure the position of the observation optical system, wherein the information about the position of the observation optical system is information acquired based on the position of the observation optical system measured by the measurement unit.

### Configuration 16

The scanning apparatus according to any one of Configurations 11 to 14, further including a driving unit configured to move the observation optical system relative to the array plate, wherein the information about the position of the observation optical system is information acquired based on a signal for driving the driving unit.

### Configuration 17

The scanning apparatus according to any one of Configurations 1 to 16, wherein the second direction is a direction perpendicular to the first direction.

### Configuration 18

The scanning apparatus according to any one of Configurations 1 to 16, wherein the second direction is a direction that is not perpendicular to the first direction but is inclined relative to the first direction.

### Configuration 19

The scanning apparatus according to any one of Configurations 1 to 16, wherein the array plate has a rectangular shape with a short side and a long side when viewed from the one surface, wherein the first direction is a direction parallel to the short side of the array plate, and wherein the second direction is a direction parallel to the long side of the array plate.

### Configuration 20

The scanning apparatus according to any one of Configurations 1 to 16, wherein the array plate has a rectangular shape with a short side and a long side when viewed from the one surface, wherein the first direction is a direction parallel to the short side of the array plate, and wherein the second direction is a direction intersecting both the short side and the long side of the array plate.

### Configuration 21

The scanning apparatus according to any one of Configurations 1 to 20, wherein the observation optical system is configured to radiate the primary light toward at least a portion of the plurality of spots and capture secondary light from the at least a portion of the plurality of spots.

### Method 1

A scanning method for causing an observation optical system to scan over an array plate including a plurality of spots on one surface, the method including performing main scanning in which the observation optical system configured to radiate primary light toward the one surface to acquire optical information related to at least a portion of the plurality of spots moves relative to the array plate in a first direction and acquires the optical information and sub-scanning in which the observation optical system moves relative to the array plate in a second direction intersecting the first direction without acquiring the optical information, and adjusting a position of the observation optical system relative to the array plate in an optical axis direction of the primary light, wherein the adjusting performs the adjustment in a period of the sub-scanning by the scanning.

### Method 2

The scanning method according to Method 1, further including acquiring information about the array plate in advance prior to the scanning, wherein the adjusting performs the adjustment based on the acquired information about the array plate.

### Program 1

A program for causing a computer to execute the scanning method according to Method 1.

The present invention is not limited to the embodiments described above, and various changes and modifications can be made without departing from the spirit and scope of the present invention. Therefore, the following claims are appended to define the scope of the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention makes it possible to acquire in-focus optical information in a short time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A scanning apparatus configured to cause an observation optical system to scan over an array plate including a plurality of spots on one surface, the scanning apparatus comprising:
an observation optical system configured to radiate primary light toward the one surface to acquire optical information related to at least a portion of the plurality of spots;
a scanning unit configured to perform main scanning in which the observation optical system moves relative to the array plate in a first direction and acquires the optical information and sub-scanning in which the observation optical system moves relative to the array plate in a second direction intersecting the first direction without acquiring the optical information; and
an adjustment unit configured to adjust a position of the observation optical system relative to the array plate in an optical axis direction of the primary light,
wherein the adjustment unit performs the adjustment in a case where the scanning unit is in a period of the sub-scanning.

2. The scanning apparatus according to claim 1, wherein in a case where the scanning unit is in a period of the main scanning, the adjustment unit does not perform the adjustment.

3. The scanning apparatus according to claim 1, further comprising an image acquisition unit configured to acquire a two-dimensional image based on an output signal from the observation optical system and information about a position of the observation optical system relative to the array plate on a plane on which the observation optical system moves relative to the array plate.

4. The scanning apparatus according to claim 1, further comprising a control unit configured to determine whether to perform the adjustment based on information about a scanning sequence performed by the scanning unit.

5. The scanning apparatus according to claim 1, further comprising a storage unit configured to store information about an imaging region defined with respect to the one surface.

6. The scanning apparatus according to claim 1, wherein the sub-scanning includes movement corresponding to two or more movement directions on a plane on which the observation optical system moves relative to the array plate.

7. The scanning apparatus according to claim 6, wherein the sub-scanning includes movement in the first direction.

8. The scanning apparatus according to claim 1, further comprising an acquisition unit configured to acquire information about the array plate,
wherein the adjustment unit performs the adjustment based on the information about the array plate acquired by the acquisition unit.

9. The scanning apparatus according to claim 8, wherein the information about the array plate includes tilt information about the array plate as viewed from the first direction.

10. The scanning apparatus according to claim 9, wherein the tilt information about the array plate is calculated based on height information about the array plate acquired at least at two points.

11. The scanning apparatus according to claim 1, wherein the scanning unit moves the observation optical system and the array plate relative to each other based on information about a position of the observation optical system and information about a position of the array plate.

12. The scanning apparatus according to claim 1, wherein the adjustment unit performs the adjustment based on information about an imaging region from which the optical information is acquired and information about a position of the observation optical system.

13. The scanning apparatus according to claim 12, wherein in a case where the position of the observation optical system is outside the imaging region, the adjustment unit performs the adjustment.

14. The scanning apparatus according to claim 12, wherein the information about the imaging region is information input in advance by a user.

15. The scanning apparatus according to claim 11, further comprising a measurement unit configured to measure the position of the observation optical system,
wherein the information about the position of the observation optical system is information acquired based on the position of the observation optical system measured by the measurement unit.

16. The scanning apparatus according to claim 11, further comprising a driving unit configured to move the observation optical system relative to the array plate,
wherein the information about the position of the observation optical system is information acquired based on a signal for driving the driving unit.

17. The scanning apparatus according to claim 1, wherein the second direction is a direction perpendicular to the first direction.

18. The scanning apparatus according to claim 1, wherein the second direction is a direction that is not perpendicular to the first direction but is inclined relative to the first direction.

19. The scanning apparatus according to claim 1,
wherein the array plate has a rectangular shape with a short side and a long side when viewed from the one surface,
wherein the first direction is a direction parallel to the short side of the array plate, and
wherein the second direction is a direction parallel to the long side of the array plate.

20. The scanning apparatus according to claim 1,
wherein the array plate has a rectangular shape with a short side and a long side when viewed from the one surface,
wherein the first direction is a direction parallel to the short side of the array plate, and
wherein the second direction is a direction intersecting both the short side and the long side of the array plate.

21. The scanning apparatus according to claim 1, wherein the observation optical system is configured to radiate the primary light toward at least a portion of the plurality of spots and capture secondary light from the at least a portion of the plurality of spots.

22. A scanning method for causing an observation optical system to scan over an array plate including a plurality of spots on one surface, the method comprising:
performing main scanning in which the observation optical system configured to radiate primary light toward the one surface to acquire optical information related to at least a portion of the plurality of spots moves relative to the array plate in a first direction and acquires the optical information and sub-scanning in which the observation optical system moves relative to the array plate in a second direction intersecting the first direction without acquiring the optical information; and
adjusting a position of the observation optical system relative to the array plate in an optical axis direction of the primary light,
wherein the adjusting performs the adjustment in a period of the sub-scanning by the scanning.

23. The scanning method according to claim 22, further comprising acquiring information about the array plate in advance prior to the scanning,
wherein the adjusting performs the adjustment based on the acquired information about the array plate.

24. A storage medium storing a program for causing a computer to execute the scanning method according to claim 22.
